(19) United States
(12) Patent Application Publication
(10) Pub. No.: US 2014/0359026 A1
(43) Pub. Date: Dec. 4, 2014

(54) DETERMINISTIC MESSAGING

(71) Applicant: Microsoft Corporation, Redmond, WA (US)

(72) Inventors: Todd Lefor, Fargo, ND (US); Steven Ernst, Fargo, ND (US)

(21) Appl. No.: 13/907,691

(22) Filed: May 31, 2013

(51) Int. Cl. H04L 12/58

(52) U.S. Cl. CPC H04L 51/02
USPC 709/206

(57) ABSTRACT

Contextual information is used in determining how to deliver a message to a user. Instead of displaying a message at a predetermined location or following a predefined routing list to deliver a message to a user, contextual information associated with the user is used in delivering the message. Different message types may be used to deliver the message. The message type that is selected for the delivery of the message may be based on different criteria (e.g. device receiving the message, priority of the message, and the like). In cases where a user does not respond to an important message within a specified time period, other messages using the same or different message types may be delivered to the user or other user(s) until a response is received.

### BACKGROUND

Computer applications generate and display messages for many different reasons. For example, an application may display a warning message or an informational message on the display. Some messages may be important messages that prevent an application from proceeding until an issue is resolved. For example, a message may be displayed indicating that the application is waiting on a selection of an option before the application can proceed. As long as a user does not select the option, the application does not proceed. Other messages may be informational messages that are not as important and may not impact a performance of the application. For example, an informational message may indicate a current state of the application. In this case, the application may continue to operate while the informational message is displayed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Contextual information is used in determining how to deliver a message to a user. Instead of displaying a message at a predetermined location or following a predefined routing list to deliver a message to a user, contextual information associated with the user is used in delivering the message. For example, the contextual information may be used to determine what computing device should receive the message. The message can be sent to the computing device currently being used by the user instead of delivering the message to the computing device that generated the message. Different message types may be used to deliver the message. The message type that is selected for the delivery of the message may be based on different criteria (e.g. the device receiving the message, a priority of the message, and the like). For example, more intrusive message types may be used to deliver high priority messages and less intrusive message types may be used for lower priority informational messages. In some cases, a low priority message may be logged and displayed to the user when the user returns to the device where the message originated. In cases where a user does not respond to an important message within a specified time period, other messages using the same or different message types may be delivered to the user or other user(s) until a response is received.

### BRIEF DESCRIPTION OF THE DRAWINGS

FIG. 1 shows a system using contextual information in determining how to deliver a message;

FIG. 2 shows delivering a low priority message to different computing devices using contextual information;

FIG. 3 shows delivering a medium priority message to different computing devices using contextual information;

FIG. 4 shows delivering a high priority message to different computing devices using contextual information;

FIG. 5 shows indicating delivery of a message on a home screen of a computing device;

FIG. 6 illustrates a process for delivering a message using contextual information and obtaining contextual information for a user;

FIG. 7 illustrates an exemplary online system for delivering a message using contextual information; and

FIGS. 8, 9A, 9B and 10 and the associated descriptions provide a discussion of a variety of operating environments in which embodiments of the invention may be practiced.

### DETAILED DESCRIPTION

Referring now to the drawings, in which like numerals represent like elements, various embodiment will be described elements, various embodiment will be described.

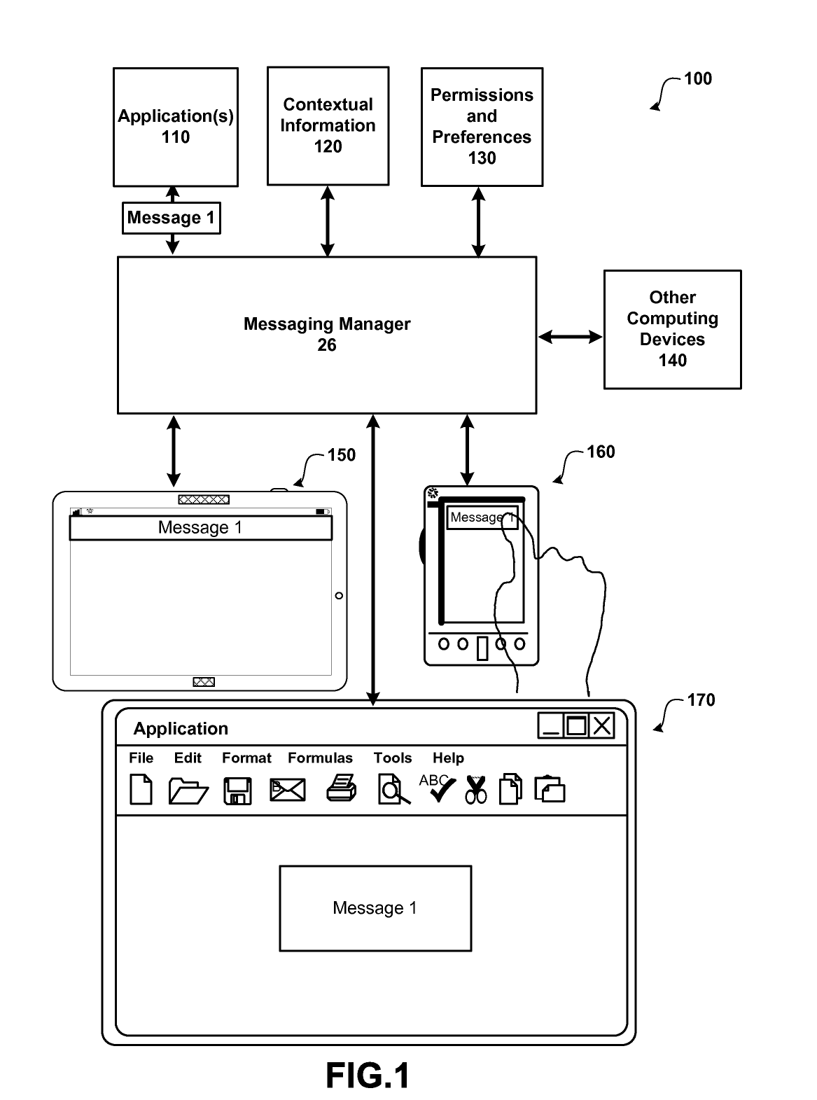

FIG. 1 shows a system using contextual information in determining how to deliver a message.

As illustrated, system 100 includes application(s) 110, contextual information 120, permissions and preferences 130, other computing devices 140, messaging manager 26, tablet computing device 150, smart phone device 160, and computing device 170.

Messaging manager 26 is configured to use contextual information 120 in determining how to deliver a message to a user. According to an embodiment, the messages delivered to a user are messages that are generated by an application or system. According to another embodiment, the messages may originate from a user. Instead of the application being programmed to display a message at a predetermined location on a display or delivering the message to a specific location, a message type and the computing device to deliver the message to is determined using contextual information 120.

Contextual information 120 stores contextual information for one or more users. Contextual information includes information relating to activity of a user. According to an embodiment, the contextual information 120 includes information about what application(s) are currently being used by the user as well as the device(s) currently in use by the user. Other contextual information may be collected and stored. The contextual information may be updated in response to an event and/or using some other method. For example, the contextual information can be updated by messaging manager 26 in response to messaging manager 26 receiving a message to deliver to a user.

A user may configure different criteria, such as permissions and preferences 130, that are related to the collection of contextual information and delivery of messages to the user. The user may set permissions that specify what information is allowed to be collected. For example, a user selects options to opt-in to allow different types of information to be collected before any information is collected or used. A user may decide to allow some types of information to be collected and decide to not allow other types of information to be collected. Access to the collected contextual information 120 is limited to an authorized user who has provided the correct security credentials. The collected contextual information 120 is stored securely until it is deleted.

Messaging manager 26 receives a message (e.g. message 1) from an application, such as application 110, to be delivered to a user. According to an embodiment, the application indicates a priority of the message (e.g. critical, urgent, high, medium, low, and the like) without specifying how or where to deliver the message. In other words, the delivery of the message is not hard-coded to a specific control that simply displays the message or delivers the message to a predefined location.

Messaging manager 26 uses the priority of the message to determine when and how the message is to be delivered. For example, more intrusive message types may be used to deliver high priority messages, and less intrusive message types for lower priority messages. In some cases, a low priority message may be logged and displayed to the user when they return to the computing device where the message was generated.

Message manager 26 selects a message type that is used for delivering the message. There are many different message types that may be used to deliver a message. Common message types include, but are not limited to: electronic mail (emails); Short Messaging Service (SMS); Enhanced Messaging Service (EMS); Multimedia Messaging Service (MMS); Instant Messaging (IM); social network posts/messages; toast notifications (e.g. a small informational window), information bar messages (e.g. within a header area), a live tile update (e.g. showing an indication of a message on an icon on a display), and the like. Messaging manager 26 may select the message type using different methods. For example, messaging manager 26 may use contextual information 120 to determine one or more commonly used message types by the user. Messaging manager 26 may also access preferences 130 to determine a message type based on an application's preferences and/or a user's preference. Messaging manager 26 may also select the message type based on the intrusiveness of the message. For example, an email received on a smart phone may not be considered as intrusive as a toast notification or some other message type.

Messaging manager 26 delivers the message after determining the computing device(s) to send the message to as well as the message type(s) to use for delivery. A message may be sent more than one time and to more than one user. For example, urgent messages may be sent to multiple devices using different message types at the same time or different times. A priority of the message may also indicate that messages should be sent to a user or a different user until a response is received. For example, in cases where a user does not respond to a high priority message within a specified time period, other messages may be delivered to the user or other user(s) using messaging manager 26 until a response is received.

Instead of following a predefined routing list to determine how to deliver a second message to a user, messaging manager 26 may obtain updated contextual information associated with the user to determine how to deliver the second message. For example, a user may have logged onto a web service using a computing device after the first message was delivered to the user at a different computing device. According to an embodiment, when a priority is not assigned to a message, a default priority level is automatically selected (e.g. low, medium, high).

In order to facilitate communication with messaging manager 26, one or more callback routines, may be implemented. Application(s) 110 may be a variety of applications, such as business productivity applications, entertainment applications, music applications, travel applications, video applications, and the like. Generally, application(s) 110 may be any application that displays messages (e.g. warning messages, informational messages, messages requesting user input, and the like). The application(s) 110 may be configured to receive different types of input (e.g. speech input, touch input, keyboard input (e.g. a physical keyboard and/or Software Input Panel (SIP)) and/or other types of input.

System 100 as illustrated comprises one or more touch screen input devices, such as tablet computing device 150 and smart phone device 160, that detects when a touch input has been received (e.g. a finger touching or nearly touching the touch screen). Any type of touch screen may be utilized that detects a user's touch input. More details are provided below.

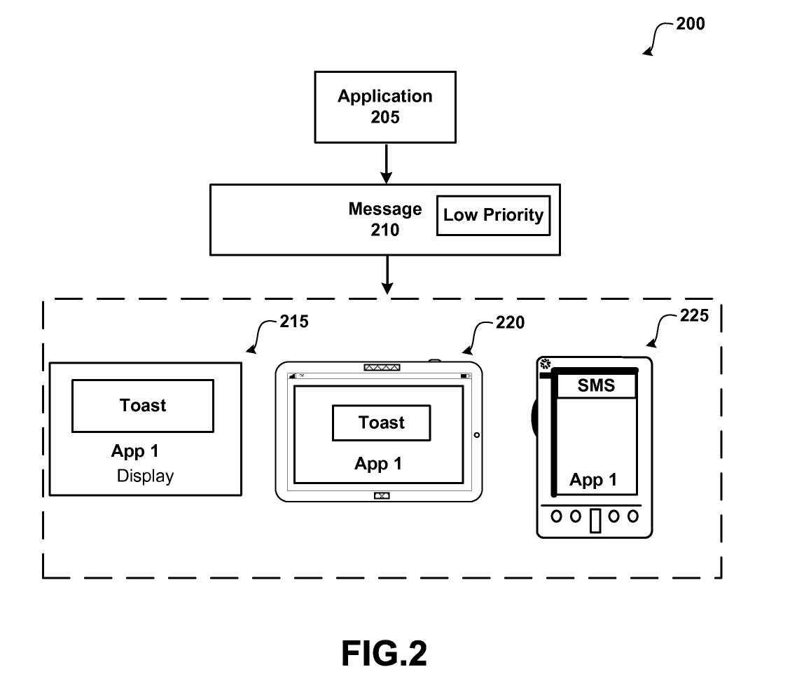

FIG. 2 shows delivering a low priority message to different computing devices using contextual information.

As illustrated, message delivery system 200 includes application 205, message 210, display 215, tablet 220, and smart phone 225. The examples provided herein are for illustration purposes and are not intended to be limiting. For example, different message types may be selected to deliver the message. The message may be delivered to different computing devices as well as different message types may be used.

Application 205 generates a low priority message 210 for delivery to a user. According to an embodiment, low priority messages are informational messages that do not expect a response from the user. While toast notifications and SMS messages are illustrated as low priority message types in system 200, other message types may be used. For example, emails, modeless dialogs, message indicators, and the like may be used to deliver low priority messages. According to an embodiment, preferences may be configured that indicate a type(s) of message to associate with low priority messages. The preferences may associate the same message type with different devices or associated different message types with different computing devices.

Display 215 shows a computing device running application (App 1) and receiving low priority message 210 in the form of a toast notification that is displayed. A toast notification displays an informational message in a small window that may automatically disappear from the display after a predetermined period of time.

Tablet 220 illustrates receiving low priority message 210 in the form of a toast notification that is displayed.

Smart phone 225 illustrates receiving low priority message 210 in the form of an SMS message.

According to another embodiment, low priority messages are stored and delivered to the user at a later time.

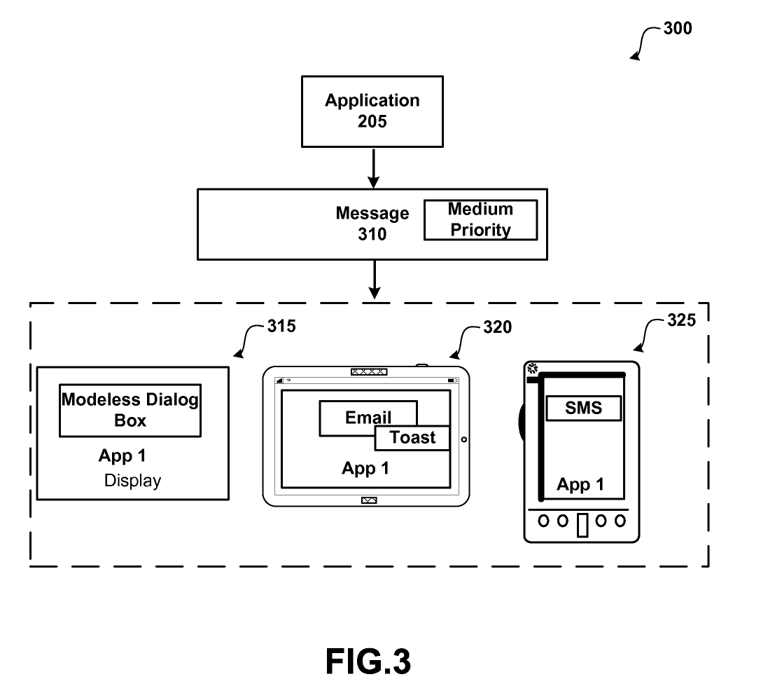

FIG. 3 shows delivering a medium priority message to different computing devices using contextual information.

As illustrated, message delivery system 300 includes application 205, message 310, display 315, tablet 320, and smart phone 325.

Application 205 generates a medium priority message 310 for delivery to a user. According to an embodiment, medium priority messages may be informational messages that do not expect a response from the user. According to another embodiment, medium priority messages may expect a response from the user. While a modeless dialog box, an email and a toast notification, and an SMS message are illustrated as medium priority message types in system 300, other message types may be used. For example, modal dialogs, MMS messages, and the like may be used to deliver medium priority messages. According to an embodiment, preferences may be configured that indicate a type(s) of message to associate with medium priority messages. The preferences may associate the same message type with different devices or associated different message types with different computing devices.

Display 315 shows a computing device running application (App 1) and receiving medium priority message 310 in a displayed modeless dialog box that may be dismissed without receiving a response from the user. Instead of automatically disappearing like a toast notification, a modeless dialog box may be displayed until a user selects an option to close the modeless dialog box.

Tablet 320 illustrates receiving medium priority message 310 in the form of an email and a toast notification. Instead of just sending the message as one message type, multiple message types may be used to send a message. In the current example, both a toast notification is used to inform the user as well as delivering an email to the user.

Smart phone 325 illustrates receiving medium priority message 310 in the form of an SMS message. A same message type may be used to send different messages having a different priority.

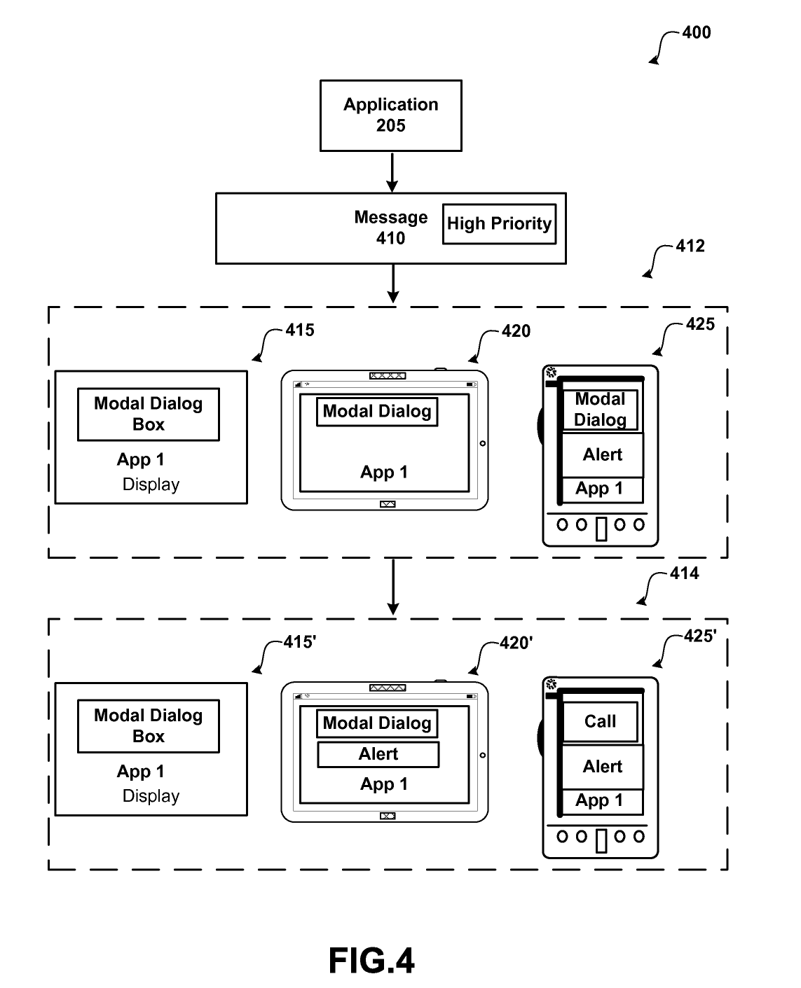

FIG. 4 shows delivering a high priority message to different computing devices using contextual information.

As illustrated, message delivery system 400 includes application 205, message 410, display 415, tablet 420, smart phone 425, and display 415′, tablet 420′, and smart phone 425′.

Application 205 generates a high priority message 410 for delivery to a user. According to an embodiment, high priority messages expect a response from the user. While modal dialog boxes, telephone calls, and alert notifications are illustrated as high priority message types in system 400, other message types may be used. For example, SMS messages, MMS messages, emails, and the like may be used to deliver high priority messages. According to an embodiment, preferences may be configured that indicate a type(s) of message to associate with high priority messages. The preferences may associate the same message type with different devices or associated different message types with different computing devices.

System 400 illustrates two different attempts (412 and 414) to deliver a high priority message. More attempts may be made to the same or a different user. According to an embodiment, messages are delivered until a response is received.

Display 415 shows a computing device running application (App 1) and receiving high priority message 410 in a displayed modal dialog box that is not dismissed until a response is received from the user.

Tablet 420 illustrates receiving high priority message 410 in the form of a modal dialog. Instead of displaying a modeless dialog that may be easily dismissed, a modal dialog box remains displayed until the user selects an action.

Smart phone 425 illustrates receiving high priority message 410 in the form of a modal dialog along with an alert. The alert may be one or more types of alerts. For example, the alert may be: a sound alert, a vibration alert, a light alert (e.g. LED lights up), and the like. Alerts may also be used with the delivery of other messages having a different priority.

When the user does not respond to a high priority message, another message is delivered to one or more computing devices to the same user and/or to different users. According to an embodiment, the computing device(s) are selected based on contextual information that is obtained after sending the previous message as shown in first attempt 412.

Display 415′ shows message 410 being displayed as another modal dialog box.

Tablet 420′ illustrates receiving high priority message 410 in the form of a modal dialog along with an alert. The alert may be one or more types of alerts.

Smart phone 425′ illustrates receiving high priority message 410 in the form of a telephone call along with an alert. The alert may be one or more types of alerts.

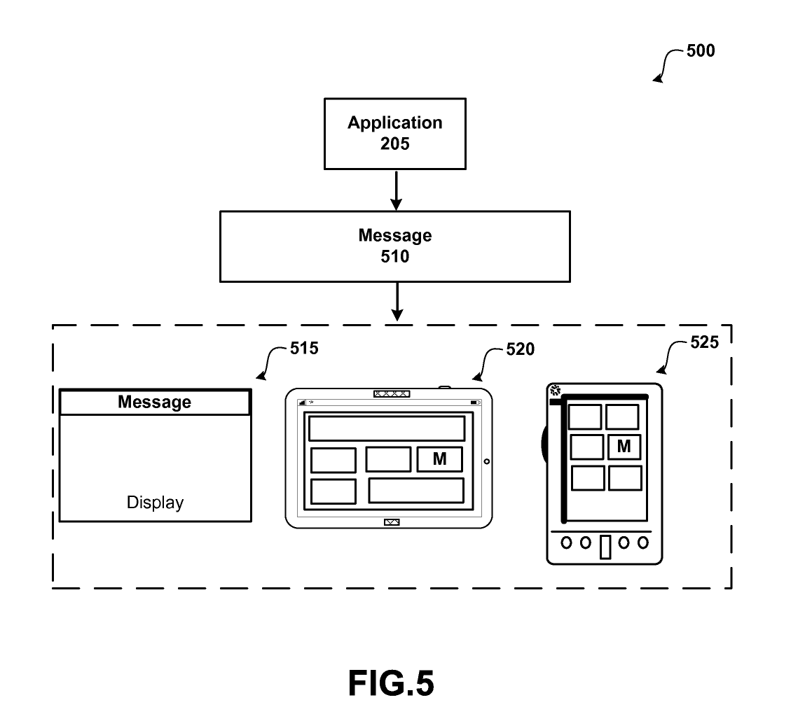

FIG. 5 shows indicating delivery of a message on a home screen of a computing device.

As illustrated, message delivery system 500 includes application 205, message 510, display 515, tablet 520, and smart phone 525.

Application 205 generates a message 510 for delivery to a user. According to an embodiment, the message may be set to any priority level.

System 500 illustrates showing that a message is received on a home screen of a computing device.

Display 515 shows a computing device indicating that it has received message 510 in an information window.

Tablet 520 and smart phone 520 illustrates a home screen with different icons/tiles displayed. When message 510 is received, an indicator may be shown with an associated icon for the application. In the current example, one of the icons displays an “M” indicating that a new message has been received. According to another embodiment, a numerical indicator (e.g. 1, 2, 3, . . . ) may be displayed that indicates the number of messages received.

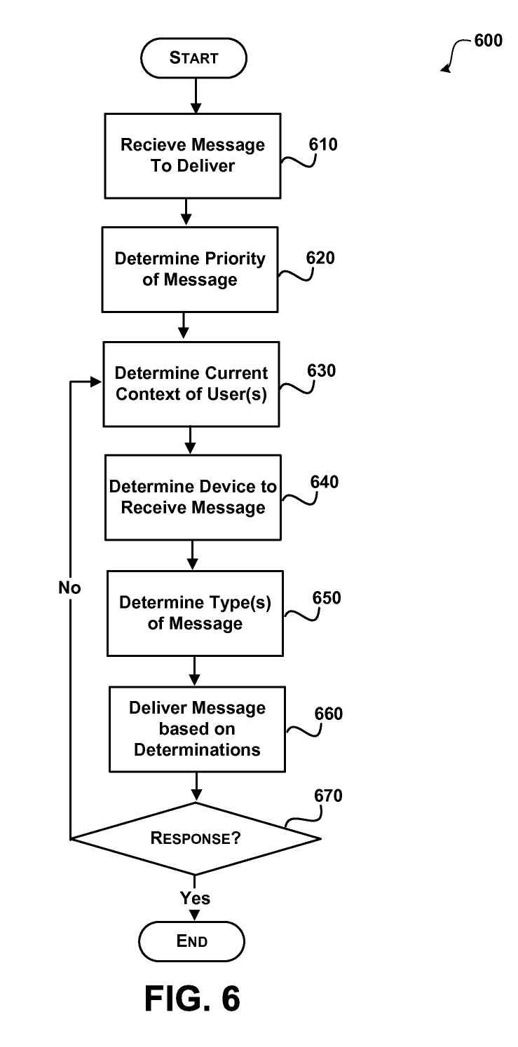

FIG. 6 illustrates a process 600 for delivering a message using contextual information and obtaining contextual information for a user. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof. While the operations are shown in a particular order, the order of the operations may change, be performed in parallel, depending on the implementation.

After a start operation, the process moves to operation 610, where a message is received to be delivered to a user. The message may be received from an application, a system, or from a user.

Flowing to operation 620, a priority of the message is determined According to an embodiment, the application specifies the priority of the message. The priority of the message may be used in determining a message type and whether or not a response from the user is expected. The priority may be set using different methods (e.g. critical, urgent, high, medium, low, 1, 2, . . . ). Generally, any prioritization scheme may be used.

Transitioning to operation 630, the context of the user(s) to receive the delivery of the message are determined According to an embodiment, the context is a current context of the user that is determined after receiving the message to be delivered. According to an embodiment, the contextual information includes information about what application(s) are currently being used by the user as well as the device(s) currently in use by the user.

Flowing to operation 640, one or more devices are determined to receive the message. For example, a computing device that is determined to be currently in use by the user may be determined to receive the message. According to an embodiment, multiple computing devices are selected for high priority messages.

Transitioning to operation 650, the message type(s) to use in delivering the message are determined. For example, more intrusive message types may be used to deliver high priority messages and less intrusive message types for lower priority messages. According to an embodiment, preferences may be accessed to determine message type(s) used to deliver the message.

Flowing to operation 660, the message is delivered to the user using the determined message type(s) to one or more computing devices.

Moving to decision operation 670, a determination is made as to whether a response is received. As discussed, some messages are informational and do not expect a response, whereas other messages expect a response. For example, messages having a high priority level may expect a response whereas low priority messages would not expect a response. When a response to a message is expected but has not been received, the process returns to operation 630. When a response has been received, or a response is not expected, the process flows to an end operation and returns to processing other actions.

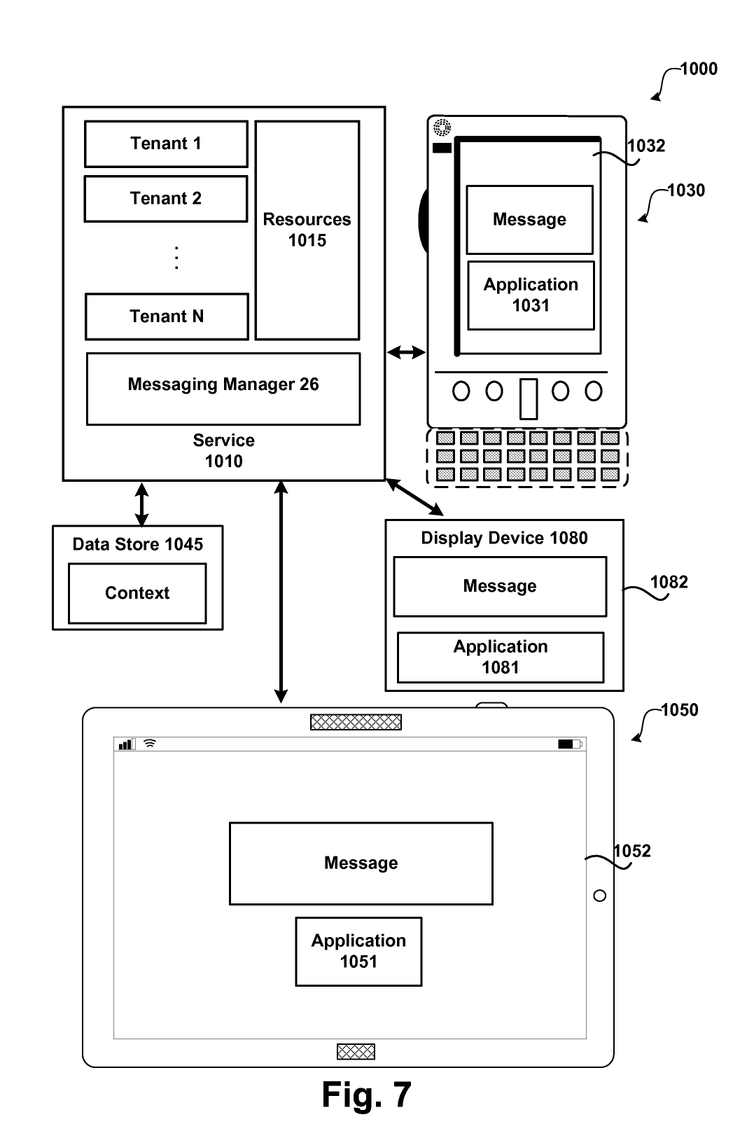

FIG. 7 illustrates an exemplary online system for delivering a message using contextual information. As illustrated, system 1000 includes service 1010, data store 1045, touch screen input device 1050 (e.g. a slate), smart phone 1030 and display device 1080.

As illustrated, service 1010 is a cloud based and/or enterprise based service that may be configured to provide services, such as Enterprise Application Software (EAS) services, Customer Relationship Management (CRM) services, productivity services (e.g. spreadsheets, documents, presentations, charts, messages, . . . ) and the like. The service may be interacted with using different types of input/output. For example, a user may use speech input, touch input, hardware based input, and the like. The service may provide speech output that combines pre-recorded speech and synthesized speech. Functionality of one or more of the services/applications provided by service 1010 may also be configured as a client/server based application.

As illustrated, service 1010 is a multi-tenant service that provides resources 1015 and services to any number of tenants (e.g. Tenants 1-N). Multi-tenant service 1010 is a cloud based service that provides resources/services 1015 to tenants subscribed to the service and maintains each tenant's data separately and protected from other tenant data.

System 1000 as illustrated comprises a touch screen input device 1050 (e.g. a slate/tablet device) and smart phone 1030 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 1030, touch screen input device 1050, and device 1080 are configured with an application (1031, 1051, 1081).

As illustrated, touch screen input device 1050, smart phone 1030, and display device 1080 shows exemplary displays 1052/1032/1082 showing the use of an application. Data may be stored on a device (e.g. smart phone 1030, slate 1050 and/or at some other location (e.g. network data store 1045). Data store 1045, or some other store, may be used to store contextual information as well as other data. The applications used by the devices may be client based applications, server based applications, cloud based applications and/or some combination. According to an embodiment, display device 1080 is a device such as a MICROSOFT XBOX coupled to a display.

Messaging manager 26 is configured to perform operations relating to delivering messages using contextual information as described herein. While manager 26 is shown within service 1010, the functionality of the manager may be included in other locations (e.g. on smart phone 1030 and/or slate device 1050 and/or device 1080).

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

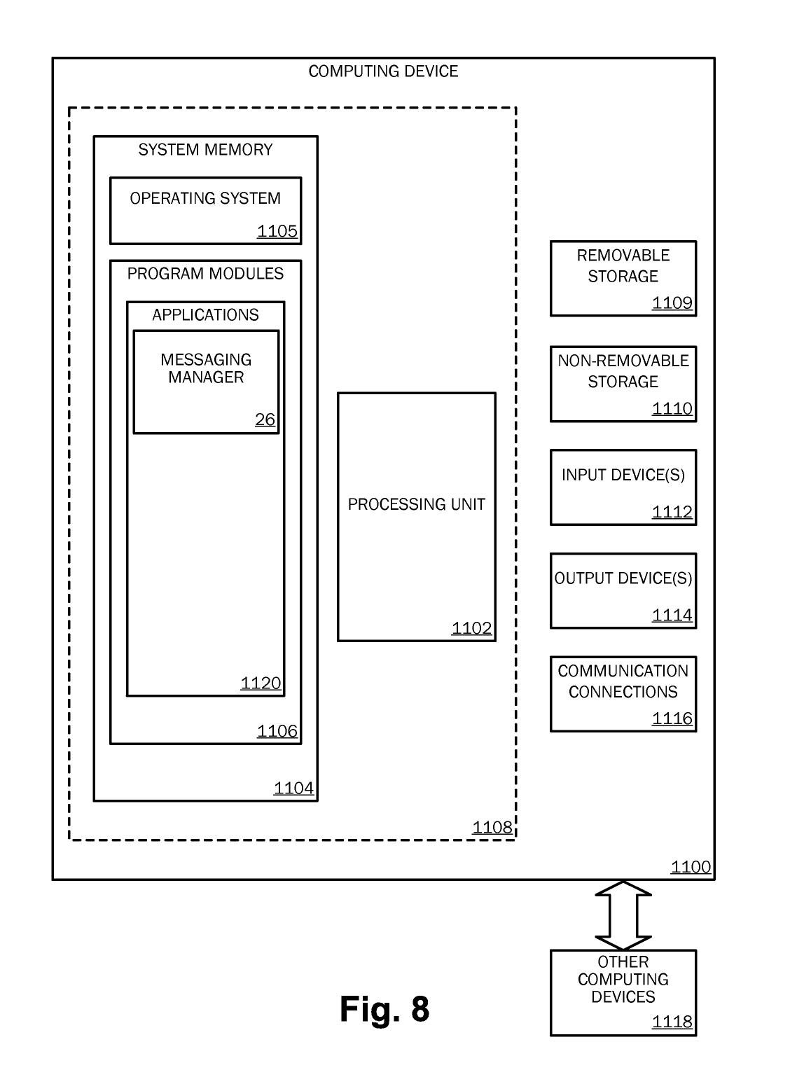

FIGS. 8-10 and the associated descriptions provide a discussion of a variety of operating environments in which embodiments of the invention may be practiced. However, the devices and systems illustrated and discussed with respect to FIGS. 8-10 are for purposes of example and illustration and are not limiting of a vast number of computing device configurations that may be utilized for practicing embodiments of the invention, described herein.

FIG. 8 is a block diagram illustrating physical components (i.e., hardware) of a computing device 1100 with which embodiments of the invention may be practiced. The computing device components described below may be suitable for the computing devices described above. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the messaging manager 26. The operating system 1105, for example, may be suitable for controlling the operation of the computing device 1100. Furthermore, embodiments of the invention may be practiced in conjunction with a graphics library, other operating systems, or any other application program and is not limited to any particular application or system. This basic configuration is illustrated in FIG. 8 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 8 by a removable storage device 1109 and a non-removable storage device 1110.

As stated above, a number of program modules and data files may be stored in the system memory 1104. While executing on the processing unit 1102, the program modules 1106 (e.g., the messaging manager 26) may perform processes including, but not limited to, one or more of the stages of the methods and processes illustrated in the figures. Other program modules that may be used in accordance with embodiments of the present invention may include electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the messaging manager 26 may be operated via application-specific logic integrated with other components of the computing device 1100 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

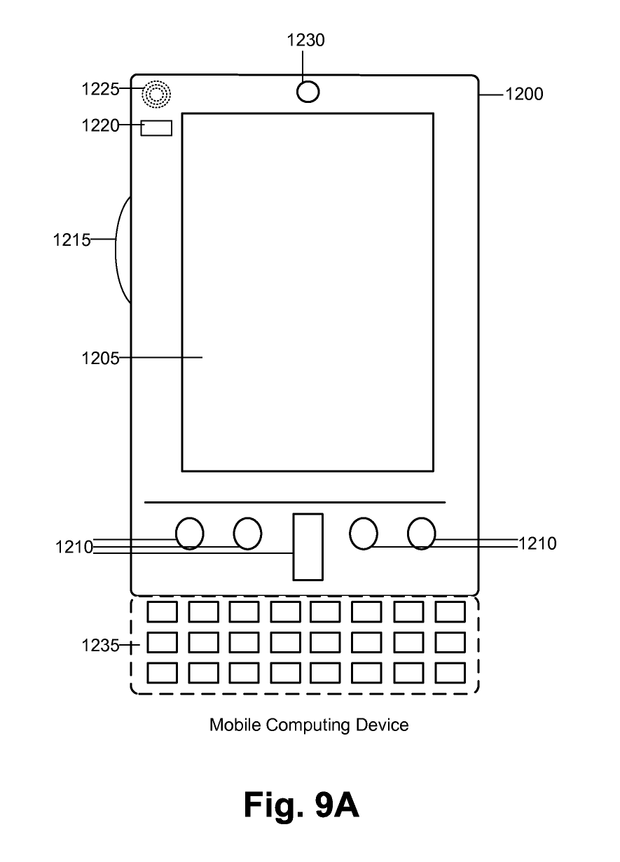

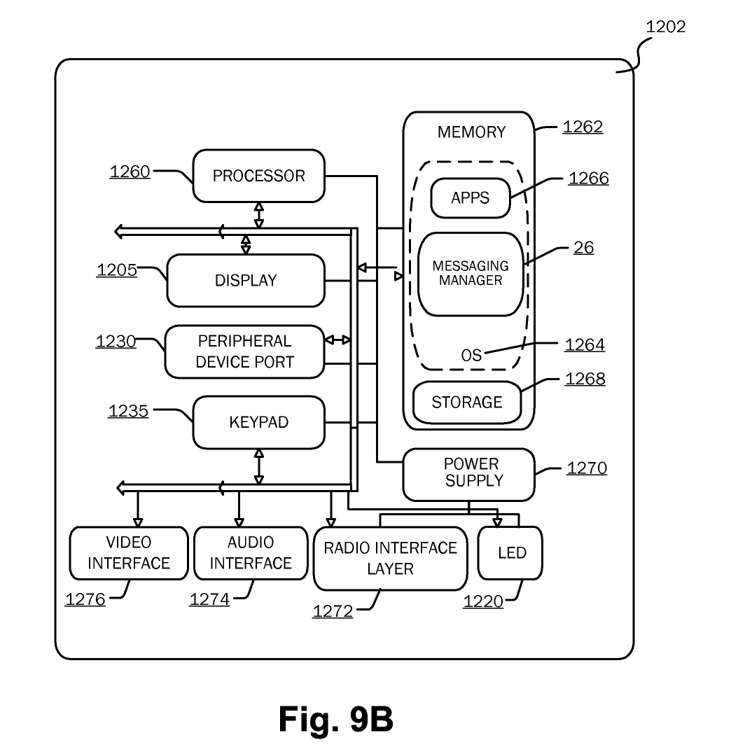

FIGS. 9A and 9B illustrate a mobile computing device 1200, for example, a mobile telephone, a smart phone, a tablet personal computer, a laptop computer, and the like, with which embodiments of the invention may be practiced. With reference to FIG. 9A, one embodiment of a mobile computing device 1200 for implementing the embodiments is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative embodiments, mobile computing device 1200 may incorporate more or less input elements. For example, the display 1205 may not be a touch screen in some embodiments. In yet another alternative embodiment, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various embodiments, the output elements include the display 1205 for showing a graphical user interface (GUI), a visual indicator 1220 (e.g., a light emitting diode), and/or an audio transducer 1225 (e.g., a speaker). In some embodiments, the mobile computing device 1200 incorporates a vibration transducer for providing the user with tactile feedback. In yet another embodiment, the mobile computing device 1200 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one embodiment of a mobile computing device. That is, the mobile computing device 1200 can incorporate a system (i.e., an architecture) 1202 to implement some embodiments. In one embodiment, the system 1202 is implemented as a “smart phone” capable of running one or more applications (e.g., browser, e-mail, calendaring, contact managers, messaging clients, games, and media clients/players). In some embodiments, the system 1202 is integrated as a computing device, such as an integrated personal digital assistant (PDA) and wireless phone.

One or more application programs 1266 may be loaded into the memory 1262 and run on or in association with the operating system 1264. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. A synchronization application (not shown) also resides on the system 1202 and is programmed to interact with a corresponding synchronization application resident on a host computer to keep the information stored in the non-volatile storage area 1268 synchronized with corresponding information stored at the host computer. As should be appreciated, other applications may be loaded into the memory 1262 and run on the mobile computing device 1200, including the messaging manager 26 as described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The visual indicator 1220 may be used to provide visual notifications, and/or an audio interface 1274 may be used for producing audible notifications via the audio transducer 1225. In the illustrated embodiment, the visual indicator 1220 is a light emitting diode (LED) and the audio transducer 1225 is a speaker. These devices may be directly coupled to the power supply 1270 so that when activated, they remain on for a duration dictated by the notification mechanism even though the processor 1260 and other components might shut down for conserving battery power. The LED may be programmed to remain on indefinitely until the user takes action to indicate the powered-on status of the device. The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. In accordance with embodiments of the present invention, the microphone may also serve as an audio sensor to facilitate control of notifications, as will be described below. The system 1202 may further include a video interface 1276 that enables an operation of an on-board camera to record still images, video stream, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 9B by the non-volatile storage area 1268. Mobile computing device 1200 may also include peripheral device port 1230.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

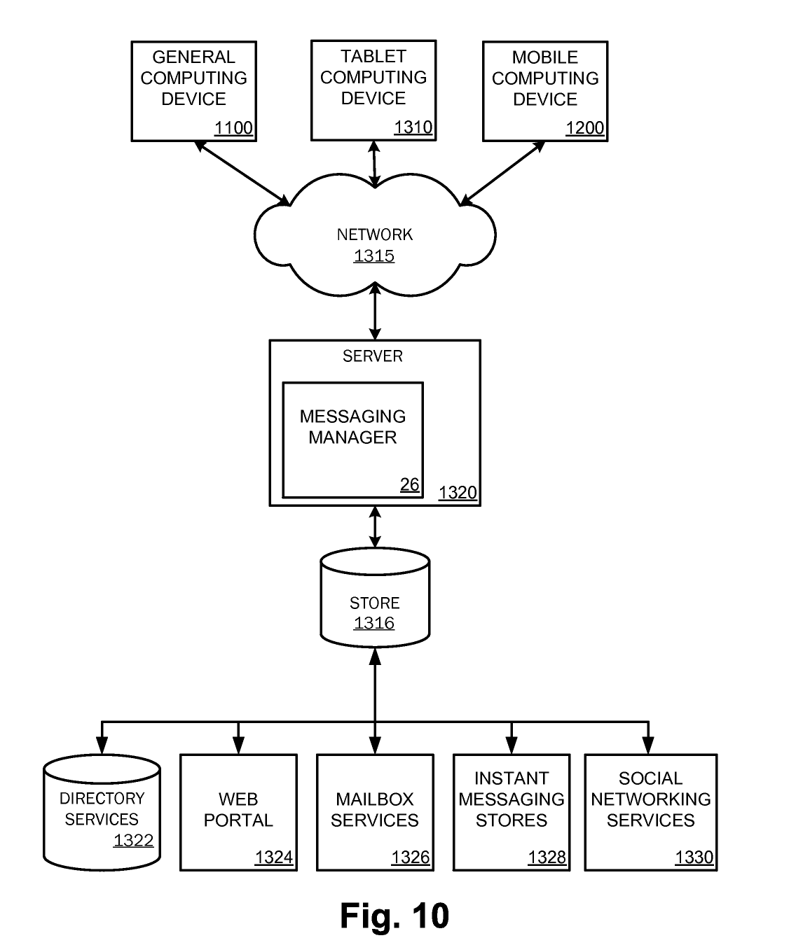

FIG. 10 illustrates an embodiment of an architecture of a system for deterministic messaging, as described above. Content developed, interacted with, or edited in association with the messaging manager 26 may be stored in different communication channels or other storage types. For example, various documents may be stored using a directory service 1322, a web portal 1324, a mailbox service 1326, an instant messaging store 1328, or a social networking site 1330. The messaging manager 26 may use any of these types of systems or the like for enabling data utilization, as described herein. A server 1320 may provide the messaging manager 26 to clients. As one example, the server 1320 may be a web server providing the messaging manager 26 over the web. The server 1320 may provide the messaging manager 26 over the web to clients through a network 1315. By way of example, the client computing device may be implemented as the computing device 1100 and embodied in a personal computer, a tablet computing device 1310 and/or a mobile computing device 1200 (e.g., a smart phone). Any of these embodiments of the client computing device 1100, 1310, 1200 may obtain content from the store 1316.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

What is claimed is:

1. A method for delivering a message, comprising:
determining a message to deliver from an application to a user;
determining a context that is associated with the user;
determining a device and a message type to deliver the message using the context that is associated with the user; and
delivering the message to the device using the determined message type.

2. The method of claim 1, wherein determining the context comprises determining a type of computing device currently being used.

3. The method of claim 1, wherein determining the context comprises determining an application and a type of computing device currently being used.

4. The method of claim 1, further comprising determining a priority of the message to deliver to the user and selecting the message type based on the priority of the message.

5. The method of claim 1, wherein the message type comprises:
electronic messages (emails); Short Messaging Service (SMS); Instant Messaging (IM); social network posts; a toast notification; and a telephone call.

6. The method of claim 1, wherein determining the context that is associated with the user comprises updating the context in response to a determination that the user has changed computing devices.

7. The method of claim 1, further comprising in response to a determination that the delivered message is not responded to within a predetermined period of time, delivering the message to a different computing device or using a different message type.

8. The method of claim 1, further comprising accessing preferences associated with the user that define message type preferences.

9. The method of claim 1, wherein determining the device and the message type to deliver the message using the context that is associated with the user changes in response to an application currently being accessed.

10. A computer-readable medium storing computer-executable instructions for delivering a message, comprising:
receiving a message from an application to deliver to a user;
determining a context that is associated with the user;
determining a device and a message type to deliver the message using the context that is associated with the user and a priority of the message; and
delivering the message to the device using the determined message type.

11. The computer-readable medium of claim 10, wherein determining the context comprises determining an application and a type of computing device currently being used.

12. The computer-readable medium of claim 10, further comprising delivering another message when a response has not been received within a predetermined period of time.

13. The computer-readable medium of claim 10, wherein the priority of the message is assigned by the application.

14. The computer-readable medium of claim 10, further comprising updating the context in response to a determination that the user has changed computing devices.

15. The computer-readable medium of claim 10, further comprising in response to a determination that the delivered message is not responded to within a predetermined period of time, delivering the message to a different computing device or using a different message type.

16. The computer-readable medium of claim 10, further comprising accessing preferences associated with the user that define message type preferences to associate with different assigned priorities.

17. A system for delivering a message, comprising:
a processor and memory;
an operating environment executing using the processor; and
a messaging manager that is configured to perform actions comprising:
receiving a message to deliver to a user;
determining a context that is associated with the user including determining a computing device currently being used;
determining a message type to deliver the message to the computing device using the context that is associated with the user; and
delivering the message to the computing device using the determined message type.

18. The system of claim 17, wherein determining the context comprises determining an application and a type of computing device currently being used.

19. The system of claim 17, further comprising determining a priority of the message assigned by the application that is used to select the message type.

20. The system of claim 17, further comprising delivering the message to a different computing device or using a different message type when the message is a high priority message.
